(19) United States
(12) Patent Application Publication
(10) Pub. No.: US 2013/0338814 A1
(43) Pub. Date: Dec. 19, 2013

(54) NUMERICAL CONTROLLER FOR MACHINE TOOL WITH WORK SUPPORTING CONTROL PART

(71) Applicant: FANUC CORPORATION, Yamanashi (JP)

(72) Inventors: Hiroyuki UCHIDA, Minamitsuru-gun (JP); Susumu MAEKAWA, Minamitsuru-gun (JP)

(73) Assignee: FANUC CORPORATION, Yamanashi (JP)

(21) Appl. No.: 13/798,223

(22) Filed: Mar. 13, 2013

(30) Foreign Application Priority Data
Jun. 13, 2012 (JP) 2012-133968

(51) Int. Cl. G05B 19/18

(52) U.S. Cl. CPC G05B 19/18
USPC 700/180

(57) ABSTRACT

A numerical controller has a work supporting control part that supports a work in manufacture or maintenance of a machine tool to be controlled. The work supporting control part has a motor drive command storage part that stores motor drive commands associated with work items. When a work item is selected on a screen, a guidance that describes the content of the work item and a setting item or check item associated with the work item are displayed on the screen. Then, in response to an operation signal output from an operation part, a motor drive command associated with the selected work item is read from the motor drive command storage part and output to a driving control part.

### BACKGROUND OF THE INVENTION

1. Field of the Invention

The present invention relates to a numerical controller for a machine tool that has a control part for supporting a work in a manufacturing process of a machine tool or a work in maintenance by a machine tool manufacturer or the like.

2. Description of the Related Art

Manufacture or maintenance of a machine tool involves assembly of components of the machine tool or attachment of various parts to the machine tool. In the process, various adjustments or measurements are performed by activating a servo motor or a spindle motor to drive a table or a main spindle. The work involved in the process of manufacture is described in the work procedure manual (which is printed on paper or stored in a personal computer or other equipment, for example), and the worker refers to the manual during the work. However, working while referring to the work procedure manual has a problem of poor workability because a space is required for the worker to refer to the manual. A skilled worker may be able to perform the work without the work procedure manual, but in that case, the worker may miss a modification to the work procedure or the cautions in performing the work involved in a design change and therefore make a mistake.

In assembly, adjustment or measurement of various components of a machine tool, a servo motor or a spindle motor needs to be activated to drive a table or a main spindle of the machine tool. To this end, according to the prior art, the worker inputs the program for activating the motor to the numerical controller directly or via an external apparatus. However, if the worker erroneously inputs the program commands to the numerical controller or selects a wrong program from the external apparatus, the table or the main spindle may operate in an unexpected way and be dangerous to the worker. In addition, it takes some time to input the program to the numerical controller.

According to the prior art, in order to keep a record of the adjustments or measurements, the worker manually completes a predetermined form or inputs necessary information to a personal computer or other equipment. This poses problems that a work space for completing the form is needed, personal computers or other equipment have to be prepared for the number of workers, and the workers have to leave their worksite to complete the form or input the information to the computer at a different site. In addition, the operation may have to be stopped in order to move to another site or put off the working gloves to hold a pen or operate a keyboard.

As a technique for solving a problem caused by an operation error or malfunction in a manufacturing process, Japanese Patent Application Laid-Open No. 2005-182598 discloses a method of canceling a special mode (factory mode) in the case where an electric apparatus is shipped in the special mode due to some failure. However, this technique is a technique for cancelling the special mode and shifting to the normal mode without the user being aware of it when the electric apparatus is shipped from the factory in the special mode because of an operation error, a malfunction or other failure in the factory, and is not designed to display the work procedure on a display device in the manufacturing factory.

Japanese Patent Application Laid-Open No. 9-262745 discloses a system that indicates a work in manufacturing of a product. However, this system is designed to display the work instruction information on a display device, such as a personal computer and a display, and requires a display device separate from the manufacturing system. Since the display device is not integrated with the manufacturing system, it is inconvenient to check the work instruction during the work, and there is also a security problem that the operator cannot immediately stop the manufacturing system when some abnormality occurs when the operator is checking the work instruction.

### SUMMARY OF THE INVENTION

In view of the problems of the prior art described above, an object of the present invention is to incorporate a function of supporting a work in the manufacturing process of a machine tool or a work in maintenance of the machine tool by the machine tool manufacturer or the like, such as display of a work procedure, input, adjustment and measurement of measurement data or the like, in a numerical controller for the machine tool in a usable manner, thereby providing a numerical controller for the machine tool that has a work supporting control part that can improve the working efficiency and safety of the work in the manufacturing process of the machine tool or the work in maintenance of the machine tool by the machine tool manufacturer or the like, prevent operation errors and reduce the facility cost.

A numerical controller for a machine tool according to the present invention has a driving control part for driving a motor. The numerical controller comprises a work supporting control part that supports a work in manufacture or maintenance of said machine tool. The work supporting control part includes: a work item display part that displays, on a screen, work items associated with said work, arranged in a workflow order; a work item selection part that selects any one of said work items; a guidance display part that displays, on the screen, a guidance that describes a work content of the work item selected by said work item selection part; a work detail display part that displays, on the screen, a setting item or a check item associated with the work item selected by said work item selection part; a motor drive command storage part that stores motor drive commands associated with said work items; an operation part that receives an operation by a worker; and a motor drive command output part that reads a motor drive command associated with the work item from said motor drive command storage part in response to an operation signal output from said operation part, and outputs the motor drive command to said driving control part.

According to the present invention, a work supporting control part incorporated in the numerical controller mounted on the machine tool can be used. As the work supporting control part supports a work, such as an assembly work, a precision adjustment work and an inspection work in the manufacturing process of the machine tool and a maintenance work by the machine tool manufacturer or the like, the efficiency and safety of works in the manufacturing process of the machine tool or works in maintenance of the machine tool by the machine tool manufacturer or the like can be improved, operation errors can be prevented, and the facility cost can be reduced. More specifically, a work content or procedure of each work is displayed on a screen of the numerical controller for the machine tool, anyone (including an unskilled worker) can perform the work with high efficiency and reliability. Especially, the information is displayed on the screen of the numerical controller, and no display separate from the numerical controller is used. Therefore, the work can be performed while seeing the content displayed on the screen of the numerical controller and can be immediately stopped if an abnormality occurs, so that high safety is secured. In addition, since the setting item or check item associated with the work is displayed on the screen, there is no need to move to another screen for setting or checking or to prepare a form or equipment for recording measurements or the like, so that the working efficiency is improved. Furthermore, by performing the work according to the work procedure displayed on the screen of the numerical controller, the motor drive command associated with the work item can be output to the driving control part to provide a mechanical operation required to assemble or adjust various components or parts of the machine tool. Therefore, there is no need to input the program command to drive the motor to the numerical controller, so that input errors can be prevented.

The numerical controller may further comprise means for making the work supporting control part operable.

According to the embodiment described above, the work supporting control part does not normally operate but operates only in the case where the special means is used. Therefore, the work supporting control part is operable only in a particular situation, such as in the manufacturing process of the machine tool and during maintenance by the machine tool manufacturer or the like, the numerical controller for the machine tool can be used for manufacture or maintenance of the machine tool without influencing the environment at all in which the user uses the machine tool or without bringing the work supporting control part up in user's consciousness.

The work supporting control part may further include a parameter adjustment part that adjusts a preset standard parameter setting value in response to the operation signal from the operation part. The work supporting control part may further include a parameter adjustment recording part that records a parameter identification number of a parameter adjusted by the parameter adjustment part, the adjusted parameter setting value, and a reason for the adjustment.

According to the embodiment described above, the parameter is optimized by performing the work according to the work procedure shown by the supporting control part. There is no need to calculate or set a parameter setting value according to the work. In addition, since modifications to the parameters and reasons for the modifications can be recorded, the characteristics of the machine tool during manufacture or maintenance can be recognized.

The work supporting control part may further include a work completion state storage part that stores the fact that the work of the work item selected by the work item selection part is completed, the work item display part can modify the display of the work items based on a content stored in the work completion state storage part, and the work item selection part can make the work item unselectable based on the content stored in the work completion state storage part.

According to the embodiment described above, since the work item whose work has been completed is displayed in a different manner than normal, the work progress can be easily grasped. In addition, since the work item whose work has been completed is made unselectable, the working efficiency is improved, and operation errors are prevented.

According to the present invention, with the configuration described above, a function of supporting a work in the manufacturing process of a machine tool or a work in maintenance of the machine tool by the machine tool manufacturer or the like, such as display of a work procedure, input, adjustment and measurement of measurement data or the like, is incorporated in a numerical controller for the machine tool in a usable manner, thereby providing a numerical controller for the machine tool that has a work supporting control part that can improve the working efficiency and safety of the work in the manufacturing process of the machine tool or the work in maintenance of the machine tool by the machine tool manufacturer or the like, prevent operation errors and reduce the facility cost.

### BRIEF DESCRIPTION OF THE DRAWINGS

The forgoing and other objects and feature of the invention will be apparent from the following description of preferred embodiments of the invention with reference to the accompanying drawings, in which:

FIG. 1 is a schematic diagram for illustrating a numerical controller that controls a machine tool according to the present invention;

FIG. 2 is a diagram for illustrating an example of a screen display provided by a work supporting control part;

FIG. 3 is a diagram for illustrating an association between work items and screen display contents;

FIG. 4 is a diagram for illustrating an association between work items and motor drive commands;

FIG. 5 is a diagram for illustrating an association between work items and parameters;

FIG. 6 is a diagram for illustrating a work completion flag;

FIG. 7 is a diagram for illustrating manufacturing of a machine tool provided with a numerical controller, wherein the numerical controller is connected to a host computer in a manufacturing process;

FIG. 8 is a flowchart for illustrating an operation of the numerical controller shown in FIG. 1; and

FIG. 9 is a flowchart for illustrating an operation of the host computer connected to the numerical controller for the machine tool being manufactured.

### DETAILED DESCRIPTION OF THE PREFERRED EMBODIMENTS

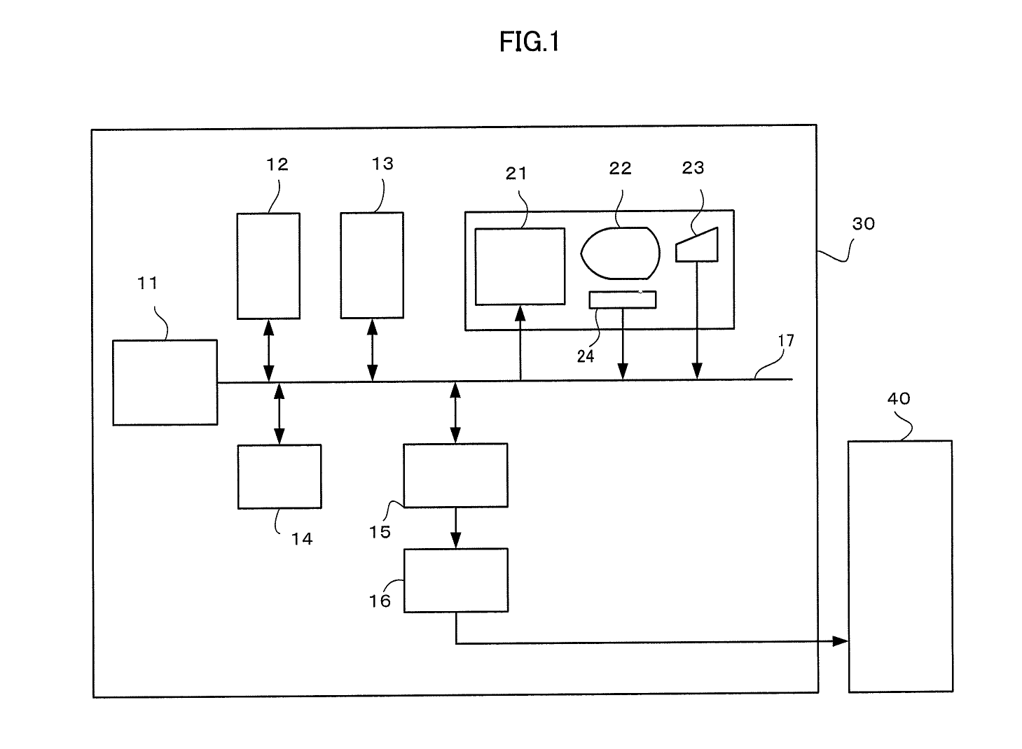

A numerical controller for controlling a machine tool according to the present invention will be schematically described with reference to FIG. 1.

A numerical controller 30 is a controller for controlling a machine tool 40. A processor 11 of the numerical controller 30 controls the whole of the numerical controller 30 according to a system program stored in a ROM 12. The ROM 12 also stores a program for performing a work supporting control. A RAM 13 is an SRAM, for example, and stores various kinds of data. A display control circuit 21 converts a digital signal into a signal suitable for display and passes the resulting signal to a display device 22. The display device 22 is a liquid crystal display device, for example. A keyboard 23 is input means used for inputting processed data or graphic data. A soft key is a button on a display screen of the display device 22 to which various function can be assigned. A plurality of soft keys are displayed on the display screen of the display device 22 at a fixed position at an end of the screen, and each soft key can be turned on and off by pressing a hardware button 24 disposed near the display device 22. An axis control circuit 15 receives an axis move command from the processor 11 and outputs the move command to a servo amplifier 16. In response to the move command, the servo amplifier 16 drives a servo motor provided in a machine tool 40.

The numerical controller 30 for the machine tool 40 incorporates software for motor driving and controlling that is required for a user to use the machine tool 40. In addition to the software originally incorporated in the numerical controller 30 for the machine tool 40, software for supporting a work or the like in the manufacturing process of the machine tool 40 is also incorporated.

The software for supporting a work or the like (hereinafter referred to as a “work supporting control part”) is designed to be enabled during the work in the manufacturing process and be disabled after the manufactured machine tool 40 is shipped from the factory. Accordingly, the numerical controller 30 for the machine tool 40 can be used for manufacturing the machine tool 40 without influencing the environment in which the user uses the machine tool 40 or without bringing the software (work supporting control part) up in user's consciousness. In addition, if means for allowing the work supporting control part to be used again even after the machine tool 40 is shipped from the factory is provided, the work supporting control part can be used for maintenance or other works by the manufacturer of the machine tool or the like.

The work supporting control part is to display a work item or a specific work procedure or work content in each manufacturing step on a screen, display information required in each work on the screen, display a setting item required in each work on the screen to allow an input operation, and allow a mechanical operation (driving of a motor) required in each work to be performed through a simple operation.

In the following, the work supporting control part will be described in detail.

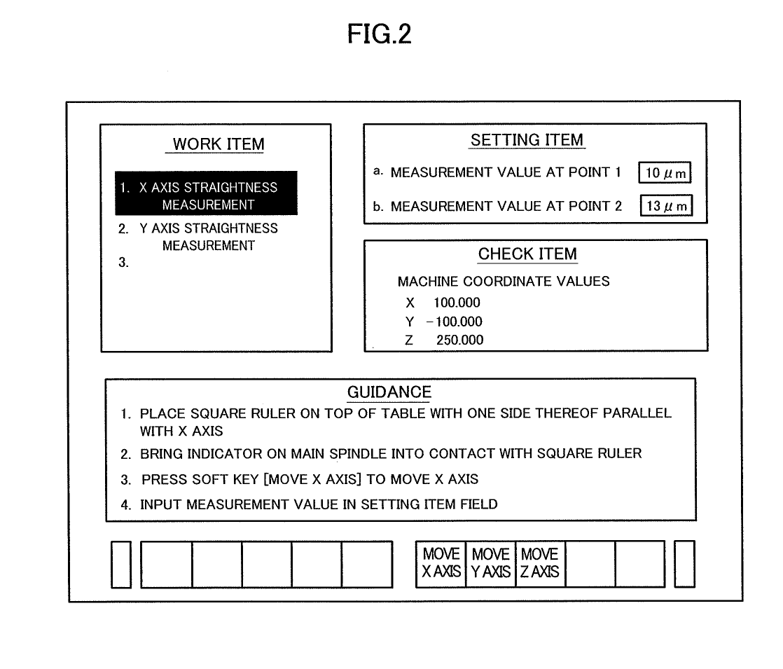

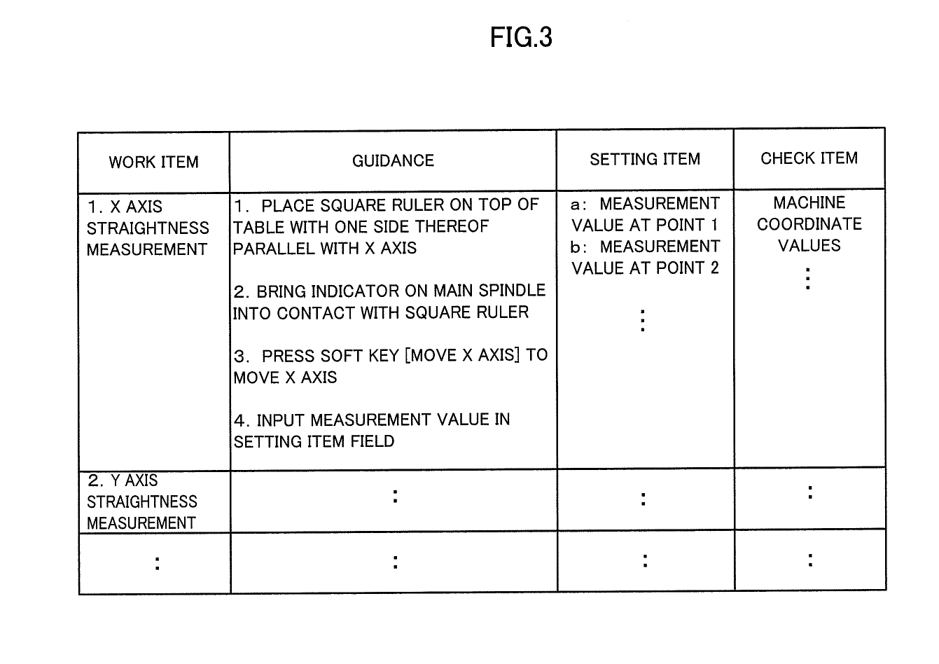

The work supporting control part is incorporated in the numerical controller 30 for the machine tool 40 in the form of software. As shown in FIGS. 2 and 3, the numerical controller 30 comprises a work item display part, a work item selection part, a guidance display part, a work detail display part, a motor drive command storage part and a motor drive command output part. The work item display part is to display, on the display screen of the display device 22, work items of works, such as an assembly work, a precision adjustment work and an inspection work in the manufacturing process of the machine tool 40 and a maintenance work by the machine tool manufacturer or the like, arranged in the workflow order by executing the software incorporated in the numerical controller 30. The work item selection part is to select a work item from among the work items displayed on the display screen of the display device 22 (a work item “1. X axis straightness measurement” is selected in the example shown in FIG. 2). The guidance display part is to display on the screen a guidance that describes the work content associated with the work item selected by the work item selection part. The work detail display part is to display a setting item and a check item on the screen. The motor drive command storage part is to store the work items displayed on the screen part of the work detail display part and motor drive commands associated with each other. The motor drive command output part is to read, from the motor drive command storage part, a motor drive command associated with the relevant work item in response to an operation signal from an operation part that receives an operation of a worker and output the motor drive command to a motor driving part.

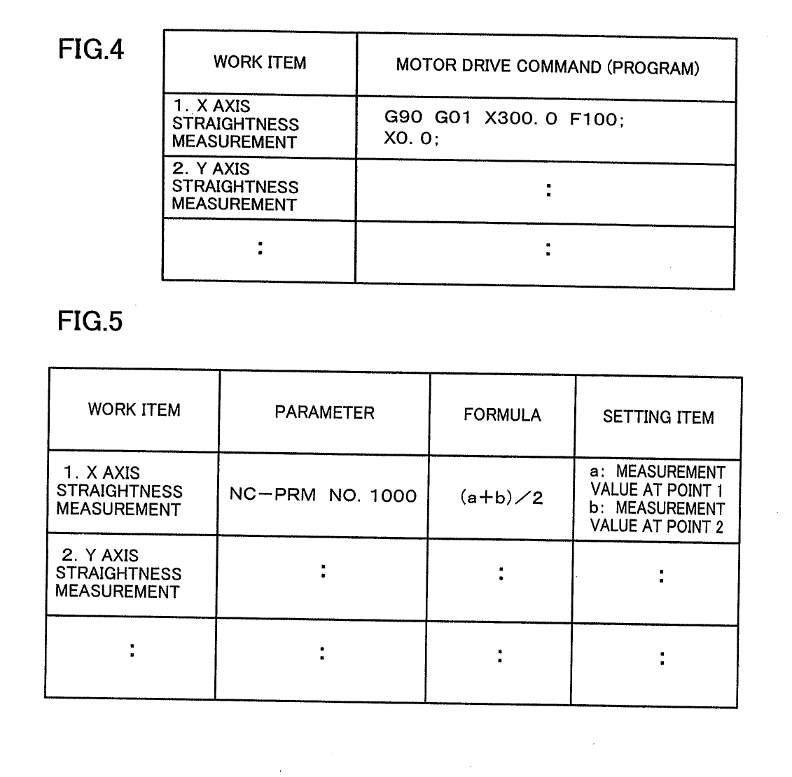

The work item selection part can carry out the selection through input of an item identification number, through the use of a cursor, or through a touch operation on a touch panel, for example. The worker can set data for the setting item displayed on the screen or check the check item displayed on the screen by operating the operation part, such as a keyboard and a pointing device, according to the work procedure. In response to the operation signal from the operation part, the work supporting control part can output the motor drive command (NC program) associated with the relevant work item to a driving control part (the axis control circuit 15) (see FIG. 4). In this way, a motor can be driven to provide a mechanical operation (operation of a main spindle or a table) that is required to assemble or adjust various components or parts of the machine tool 40.

If a standard parameter is previously set in the numerical controller 30, and the worker operates the operation part according to the work procedure, the work supporting control part automatically adjusts the parameter setting value associated with the work item in response to the operation signal from the operation part. The automatic adjustment of the parameter setting value can be achieved by previously setting a formula for calculating the parameter setting value from the value set for the setting item as shown in FIG. 5. Furthermore, the parameter identification number of the adjusted parameter, the adjusted parameter setting value and the reason for the adjustment can be recorded in a memory (a non-volatile memory 14). In this way, the parameter is optimized for the work in the manufacturing process of the machine tool 40 or the work in the maintenance by the machine tool manufacturer or the like, and the characteristics of the machine tool can be recognized from the differences from the set standard value.

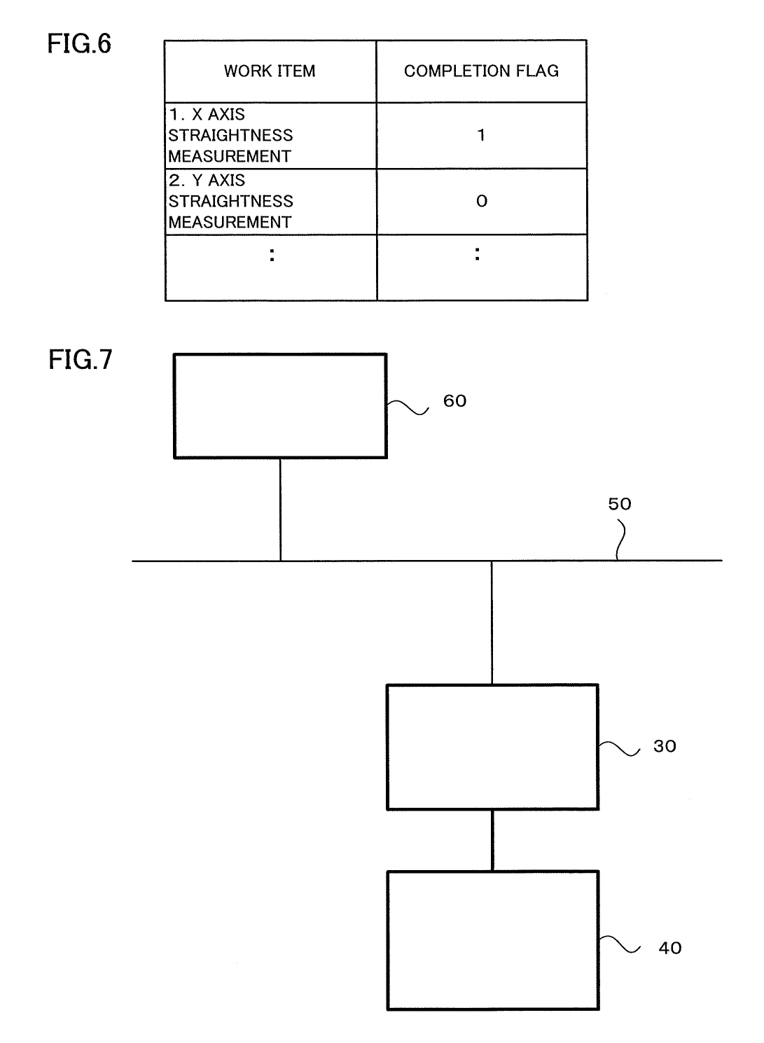

Once the work of the selected work item is completed, a work completion flag associated with the work item is set at 1 (see FIG. 6) so that the completion of the work item can be recognized. The work item whose work has been completed (the work item whose work completion flag is set at 1) is displayed in a different way, thereby making the completion of the work recognizable on the display screen. For example, the work item can be displayed in a lighter color than normal, displayed with a strikeout line, marked in the check box or the like, or deleted. In addition, the work item whose work has been completed is made unselectable.

The work supporting control part does not normally operate but operates only in the case where special means is used. The special means is operable only when the machine tool is in the manufacturing process, and therefore, the numerical controller for the machine tool is connected to and communicates with a host computer (a server) that manages the manufacturing process of the machine tool to make the work supporting control part operable.

FIG. 7 is a diagram for illustrating manufacturing of a machine tool provided with a numerical controller, wherein the numerical controller is connected to a host computer in a manufacturing process.

A host computer 60 is connected to the numerical controller 30 that controls the machine tool 40 through a communication line 50, such as the Internet. The host computer 60 has data and a program for performing a processing of checking whether or not there is a machine tool of which numerical controller has transmitted the operation permission request signal of the work supporting control part to the host computer, in the manufacturing process, by referring to production management information (information for managing each machine tool in the manufacturing process, each shipped machine tool or the like).

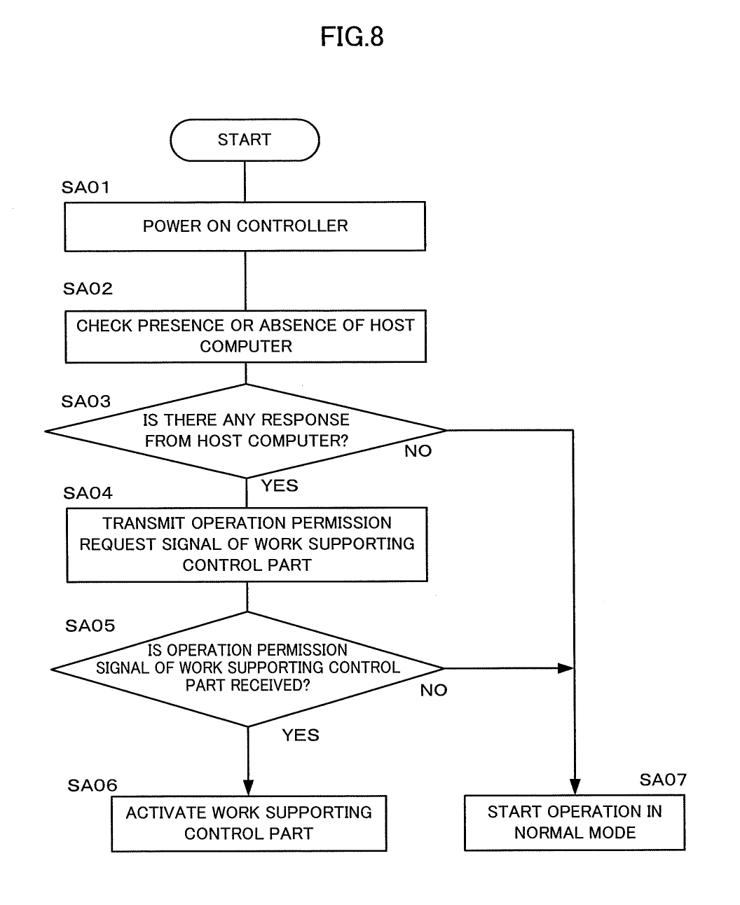

FIG. 8 is a flowchart for illustrating a process of activating the work supporting control part. In the following, the process will be described step by step.

[Step SA01] The numerical controller for the machine tool is powered on.

[Step SA02] The numerical controller for the machine tool is connected by wire or wirelessly to a network and transmits, to a host computer (server) that manages the manufacturing process of the machine tool, a command for checking the presence or absence of the host computer or server.

[Step SA03] It is determined whether or not there is a response from a host computer. If there is not a response from any host computer (if the determination result is NO), it is determined that the machine tool is not in the manufacturing process, and the process proceeds to Step SA07. If there is a response (if the determination result is YES), it is determined that the machine tool is in the manufacturing process, and the process proceeds to Step SA04.

[Step SA04] The numerical controller for the machine tool transmits an operation permission request signal of the work supporting control part to the host computer. The operation permission request signal of the work supporting control part additionally includes information for identifying the numerical controller for the machine tool (identification information specific to the numerical controller).

[Step SA05] The numerical controller for the machine tool determines whether or not the numerical controller has received an operation permission signal for the work supporting control part. If the numerical controller has received the operation permission signal (if the determination result is YES), the process proceeds to Step SA06. If the numerical controller has never received the operation permission signal (if the determination result is NO), the process proceeds to Step SA07.

[Step SA06] The work supporting control part starts operating. The work supporting control part can continue operating until the power supply of the numerical controller for the machine tool is turned off.

[Step SA07] The work supporting control part is not activated, and an operation in a normal mode (in which the user normally uses the machine tool) starts.

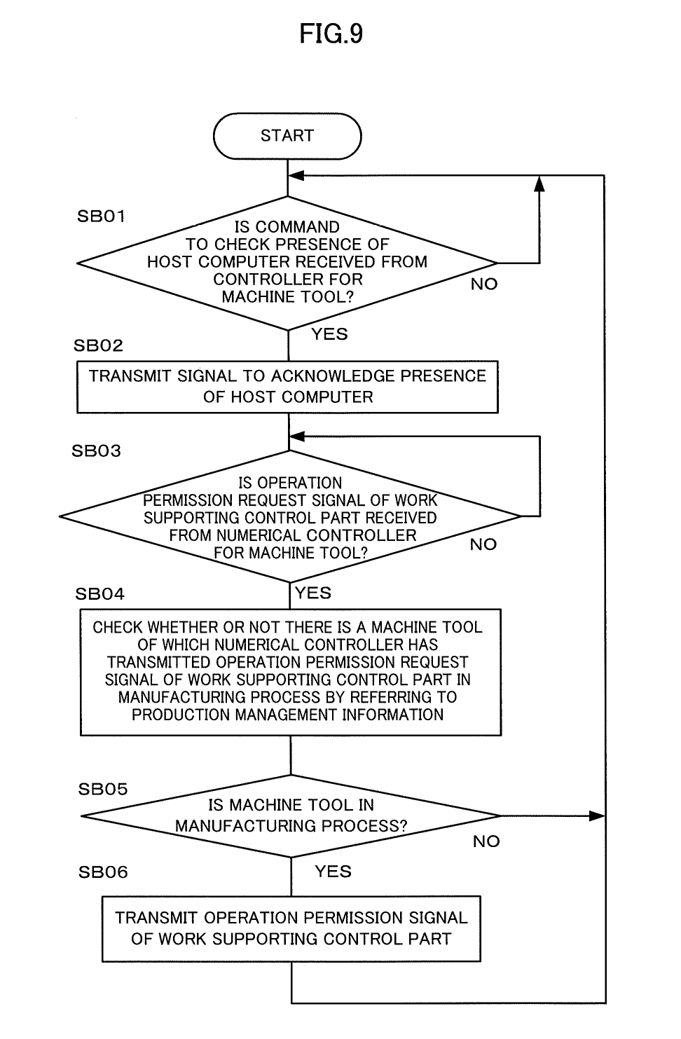

FIG. 9 is a flowchart for illustrating an operation of the host computer connected to the numerical controller for the machine tool during manufacture. In the following, the operation will be described step by step.

[Step SB01] The host computer determines whether or not the host computer has received the command for checking the presence or absence of the host computer from the numerical controller for the machine tool. If the host computer has received the command (if the determination result is YES), the process proceeds to Step SB02. If the host computer has never received the command (if the determination result is NO), the host computer waits until it receives the command, and then, the process proceeds to Step SB02.

[Step SB02] The host computer transmits a signal that acknowledges the presence of the host computer to the numerical controller for the machine tool.

[Step SB03] The host computer determines whether or not the host computer has received the operation permission request signal of the work supporting control part transmitted from the numerical controller for the machine tool. If the host computer has received the signal (if the determination result is YES), the process proceeds to Step SB04. If the host computer has never received the signal (if the determination result is NO), the host computer waits until it receives the signal, and then, the process proceeds to Step SB04.

[Step SB04] The host computer performs a processing of checking whether or not there is a machine tool of which numerical controller has transmitted the operation permission request signal of the work supporting control part to the host computer, in the manufacturing process, by referring to the production management information (information for managing each machine tool in the manufacturing process, each shipped machine tool or the like).

[Step SB05] The host computer determines whether or not there is a machine tool of which numerical controller has transmitted the operation permission request signal of the work supporting control part to the host computer, in the manufacturing process. If the machine tool is in the manufacturing process (if the determination result is YES), the process proceeds to Step SB06. If the machine tool is not in the manufacturing process (if the determination result is NO), the process returns to Step SB01.

[Step SB06] The host computer transmits the operation permission signal for the work supporting control part to the numerical controller for the machine tool, and then, the process returns to Step SB01 and continues.

In a case where the host computer 60 that manages the manufacturing process of the machine tool and the numerical controller 30 for the machine tool 40 are in a closed network in the factory that is inaccessible from the outside, processing at Steps SA04 and SA05 in FIG. 8 and processing at Steps SB03, SB04, SB05 and SB06 in FIG. 9 can be omitted.

As an alternative, the work supporting control part may be made operable by a predetermined operation so that the work supporting control part can be used after the machine tool 40 is shipped from the factory. The predetermined operation may be, for example, to press a plurality of keys on an operation panel when the numerical controller 30 is powered on or to input a cipher after the numerical controller is powered on.

According to the embodiments of the present invention described above, the numerical controller mounted on the machine tool can be used in the manufacturing process of the machine tool or for maintenance of the machine tool by the machine tool manufacturer or the like. Therefore, there are advantages that the working efficiency and safety of the manufacturing process of the machine tool or maintenance of the machine tool by the machine tool manufacturer or the like can be improved, operation errors can be prevented, and the facility cost can be reduced. Since the work supporting control part incorporated in the numerical controller for the machine tool is operable only in a particular situation, such as in the manufacturing process of the machine tool or during maintenance by the machine tool manufacturer or the like, the numerical controller for the machine tool can be used for manufacture or maintenance of the machine tool without influencing the environment in which the user uses the machine tool or without bringing the work supporting control part up in user's consciousness.

1. A numerical controller for a machine tool that has a driving control part for driving a motor, the numerical controller comprising:
a work supporting control part that supports a work in manufacture or maintenance of said machine tool,
wherein the work supporting control part includes:
a work item display part that displays, on a screen, work items associated with said work arranged, in a workflow order;
a work item selection part that selects any one of said work items;
a guidance display part that displays, on the screen, a guidance that describes a work content of the work item selected by said work item selection part;
a work detail display part that displays, on the screen, a setting item or a check item associated with the work item selected by said work item selection part;
a motor drive command storage part that stores motor drive commands associated with said work items;
an operation part that receives an operation by a worker; and
a motor drive command output part that reads a motor drive command associated with the work item from said motor drive command storage part in response to an operation signal output from said operation part, and outputs the motor drive command to said driving control part.

2. The numerical controller for a machine tool according to claim 1, further comprising:
means for making said work supporting control part operable.

3. The numerical controller for a machine tool according to claim 1, wherein said work supporting control part further includes a parameter adjustment part that adjusts a preset standard parameter setting value in response to the operation signal from said operation part.

4. The numerical controller for a machine tool according to claim 3, wherein said work supporting control part further includes a parameter adjustment recording part that records a parameter identification number of a parameter adjusted by said parameter adjustment part, the adjusted parameter setting value, and a reason for the adjustment.

5. The numerical controller for a machine tool according to claim 1, wherein said work supporting control part further includes a work completion state storage part that stores the fact that the work of the work item selected by said work item selection part is completed,
said work item display part modifies the display of the work items based on a content stored in said work completion state storage part, and
said work item selection part makes the work item unselectable based on the content stored in said work completion state storage part.

6. The numerical controller for a machine tool according to claim 2, wherein said work supporting control part further includes a work completion state storage part that stores the fact that the work of the work item selected by said work item selection part is completed,
said work item display part modifies the display of the work items based on a content stored in said work completion state storage part, and
said work item selection part makes the work item unselectable based on the content stored in said work completion state storage part.

7. The numerical controller for a machine tool according to claim 3, wherein said work supporting control part further includes a work completion state storage part that stores the fact that the work of the work item selected by said work item selection part is completed,
said work item display part modifies the display of the work items based on a content stored in said work completion state storage part, and
said work item selection part makes the work item unselectable based on the content stored in said work completion state storage part.

8. The numerical controller for a machine tool according to claim 4, wherein said work supporting control part further includes a work completion state storage part that stores the fact that the work of the work item selected by said work item selection part is completed,
said work item display part modifies the display of the work items based on a content stored in said work completion state storage part, and
said work item selection part makes the work item unselectable based on the content stored in said work completion state storage part.
